(19) United States
(12) Patent Application Publication
(10) Pub. No.: US 2020/0185715 A1
(43) Pub. Date: Jun. 11, 2020

(54) CATHODE MATERIAL AND ELECTROCHEMICAL DEVICE COMPRISING THE SAME

(71) Applicant: NINGDE AMPEREX TECHNOLOGY LIMITED, Ningde City (CN)

(72) Inventors: Fei ZHANG, Ningde City (CN); Leimin XU, Ningde City (CN); Meng WANG, Ningde City (CN); Pengwei CHEN, Ningde City (CN)

(73) Assignee: NINGDE AMPEREX TECHNOLOGY LIMITED

(21) Appl. No.: 16/429,999

(22) Filed: Jun. 3, 2019

(30) Foreign Application Priority Data
Dec. 7, 2018 (CN) 201811500034.1

(51) Int. Cl. H01M 4/525; H01M 10/0525; H01M 4/505; H01M 4/04; C01G 53/00

(52) U.S. Cl. CPC H01M 4/525; H01M 10/0525; H01M 2004/028; H01M 4/0471; C01G 53/44; H01M 4/505

(57) ABSTRACT

The present application relates to a cathode material and an electrochemical device comprising the same. The cathode material comprises a matrix and a coating layer. The matrix comprises a cathode active material capable of reversibly intercalating or deintercalating lithium ions, and the coating layer comprises an organic material having a general formula X—R—CₙFₐCl_{b}, wherein R is a hydrocarbyl and X is a siloxane group. The coating layer can not only reduce the side reaction between the electrolyte and the cathode active material in the electrochemical device, but can also act as a lithium ion conductor layer to accelerate the intercalating or deintercalating of the lithium ions. Therefore, the cathode material coated by the above coating layer has excellent rate performance and impedance characteristics while having excellent cycle stability.

### CROSS REFERENCE TO RELATED APPLICATIONS

The present application claims the benefit of priority from the China Patent Application No. 201811500034.1, filed on 7 Dec. 2018, the disclosure of which is hereby incorporated by reference in its entirety.

### BACKGROUND

### 1. Technical Field

The present application relates to the field of energy storage, and more particularly to a cathode material and an electrochemical device comprising the same.

### 2. Description of the Related Art

With the popularity of consumer electronics products such as notebook computers, mobile phones, handheld game consoles, tablet computers, mobile power supplies and drones, the requirements on electrochemical devices (for example, batteries) are more and more stringent. For example, people require not only the light weight but also the high capacity and long service life of the batteries. In the numerous batteries, lithium ion batteries have occupied a mainstream position in the market due to the outstanding advantages such as high energy density, high safety, low self-discharge, no memory effect, and long service life. The cathode material is one of the most critical components in the lithium ion battery. At present, the development of the cathode materials with high energy density, ultra high rate and good cycle performance is the focus of research and development in the field of lithium ion batteries.

### SUMMARY

The present application provides a cathode material and a method for preparing such cathode material, to attempt to solve at least one problem existing in the related fields at least to some extent.

In one embodiment, the present application provides a cathode material, comprising: a matrix, comprising a cathode active material capable of reversibly intercalating or deintercalating lithium ions; and a coating layer, disposed on the surface of the matrix; wherein the coating layer comprises an organic material having the general formula X—R—CₙFₐCl_{b}, wherein R is a hydrocarbyl and X is a siloxane group having the following general formula:

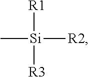

wherein R1, R2 and R3 respectively and independently represent an alkoxy group having 1 to 5 carbon atoms or an alkoxy group having 1 to 5 carbon atoms and substituted with F or Cl; n is an integer greater than or equal to 7; and a and b are integers greater than or equal to 0 respectively, and a+b=2n+1.

In some embodiments, R is a linear chain hydrocarbyl having 1 to 10 carbon atoms.

In some embodiments, a molecular formula of the organic material is X—(C_{c}H_{2c})—CₙFₐCl_{b}, wherein 1≤c≤5, and n is an integer greater than or equal to 10.

In some embodiments, a molecular formula of the organic material is (CH₃—O)₃—Si—(C₂H₄)—CₙF₍₂ₙ₊₁₎.

In some embodiments, —CₙFₐCl_{b} is linear-chain.

In some embodiments, a mass percentage of the organic material relative to the cathode active material is about 0.05 wt % to about 5 wt %.

In some embodiments, the cathode active material is lithium cobalt oxide, lithium manganese oxide, lithium nickel oxide, lithium nickel cobalt manganese oxide, lithium nickel cobalt aluminum oxide, nickel manganese spinel, or lithium iron phosphate.

In some embodiments, the cathode active material is LiNiₓCo_{y}Mn_{z}T_{d}O₂, wherein 0≤x≤1, 0≤y≤1, 0≤z≤1, wherein x, y, and z are not zero at the same time, wherein T is selected from the group consisting of Mg, Al, Ti, Ca, Si, Ga, Ge, La, Y, Zr, Sc, Nb, Mo, Ce, and combinations thereof, wherein 0≤d≤0.05.

In some embodiments, the cathode active material is LiNiₓCo_{y}Mn_{z}T_{d}O₂, wherein 0.55≤x<1, 0≤y<0.45, and 0≤z<0.45.

In another embodiment, the present application provides a cathode, wherein a cathode active material layer is formed on the surface of a cathode current collector of the cathode, and the cathode active material layer comprises one of the cathode materials in the above embodiments.

In another embodiment, the present application provides an electrochemical device, comprising a cathode, an anode, a separator, and an electrolyte, wherein the cathode comprises one of the cathode materials in the above embodiments.

In some embodiments, the electrochemical device is a lithium ion battery.

In another embodiment, the present application provides an electronic device, comprising the electrochemical device in the above embodiments.

In still another embodiment, the present application provides a method for preparing a cathode material, comprising: dissolving one of the organic materials in the above embodiments in an organic solvent, and then mixing with a cathode active material capable of reversibly intercalating or deintercalating lithium ions to obtain a mixed solution; and heating the mixed solution to evaporate the organic solvent, thereby obtaining a cathode material comprising the cathode active material coated with the organic material.

In some embodiments, the method for preparing a cathode material further comprises recovering the evaporated organic solvent.

In some embodiments, the organic solvent is selected from the group consisting of methanol, ethanol, propanol, isopropanol, and combinations thereof.

Additional aspects and advantages of the embodiments of the present application will be described and shown in part in the following explanation or set forth by implementation of the embodiments of the present application.

### BRIEF DESCRIPTION OF THE DRAWINGS

The drawings which are necessary to describe the embodiments of the present application or the prior art will be are briefly described below to facilitate the description of the embodiments of the present application. It is obvious that the drawings in the following description are only part of the embodiments of the present application. Those skilled in the art could obtain the drawings of other embodiments according to the structures illustrated in these drawings without the need to pay creative work.

FIG. 1 is a model schematic view of a cathode material coated by an organic material described according to an embodiment of the present application.

FIG. 2A is the scanning electron microscope (SEM) image of an uncoated lithium cobalt oxide synthesized in Comparative Example 1 of the present application; and FIG. 2B is the SEM image of a coated lithium cobalt oxide synthesized in Embodiment 9 of the present application.

### PREFERRED EMBODIMENT OF THE PRESENT APPLICATION

Embodiments of the present application will be described in detail below. In the specification of the present application, the same or similar components and components having the same or similar functions are denoted by similar reference sings. The embodiments described herein with respect to the drawings are explanatory and illustrative, and are intended to provide a basic understanding of the present application. The embodiments of the present application should not be construed as limiting the present application.

As used herein, the terms “substantially”, “generally”, “essentially” and “about” are used to describe and explain small variations. When used in connection with an event or circumstance, the terms may refer to an example in which the event or circumstance occurs precisely and an example in which the event or circumstance occurs approximately. For example, when used in connection with a value, the terms may refer to a range of variation less than or equal to ±10% of the value, for example, less than or equal to ±5%, less than or equal to ±4%, less than or equal to ±3%, less than or equal to ±2%, less than or equal to ±1%, less than or equal to ±0.5%, less than or equal to ±0.1%, less than or equal to ±0.05%, etc. For example, if the difference value between the two values is less than or equal to ±10% of the average of the values (for example, less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%), then the two values can be considered “substantially” the same.

In addition, quantities, ratios, and other values are sometimes presented in a range format herein. It should be understood that the range format is intended for convenience and briefness and should be understood flexibly. Not only are the values explicitly limited in the range contained, but also all individual values or sub-ranges covered within the range are contained as each value and each sub-range are explicitly specified.

The term “hydrocarbyl” covers alkyl, alkenyl and alkynyl. For example, the hydrocarbyl is expected to be a linear chain hydrocarbon structure having 1 to 20 carbon atoms. The “hydrocarbyl” is also expected to be a branched chain hydrocarbon structure having 3 to 20 carbon atoms. When the hydrocarbyl having a specific carbon number is specified, it is intended to cover all geometric isomers having such carbon number. The hydrocarbyl herein may also be the hydrocarbyl of 1 to 15 carbon atoms, the hydrocarbyl of 1 to 10 carbon atoms, the hydrocarbyl of 1 to 5 carbon atoms, the hydrocarbyl of 5 to 20 carbon atoms, the hydrocarbyl of 5 to 15 carbon atoms or the hydrocarbyl of 5 to 10 carbon atoms. Additionally, the hydrocarbyl can be optionally substituted. For example, the hydrocarbyl may be substituted with a halogen comprising fluorine, chlorine, bromine, and iodine.

The term “alkyl” is intended to be a linear chain saturated hydrocarbon structure having 1 to 20 carbon atoms. The “alkyl” is also expected to be a branched chain structure having 3 to 20 carbon atoms. For example, the alkyl may be the alkyl of 1 to 20 carbon atoms, the alkyl of 1 to 10 carbon atoms, the alkyl of 1 to 5 carbon atoms, the alkyl of 5 to 20 carbon atoms, the alkyl of 5 to 15 carbon atoms or the alkyl of 5 to 10 carbon atoms. When the alkyl having a specific carbon number is specified, it is intended to cover all geometric isomers having such carbon number. Therefore, for example, “butyl” refers to n-butyl, sec-butyl, isobutyl and tert-butyl. “Propyl” comprises n-propyl and isopropyl. Examples of the alkyl comprise, but not limited to, methyl, ethyl, n-propyl, isopropyl, n-butyl, isobutyl, sec-butyl, tert-butyl, n-pentyl, isopentyl, neopentyl, N-hexyl, isohexyl, n-heptyl, octyl, norbornyl and the like. Additionally, the alkyl can be optionally substituted.

The term “alkenyl” refers to a monovalent unsaturated hydrocarbyl group which may be linear-chain or branched-chain and has at least one and usually one, two or three carbon-carbon double bonds. Unless otherwise defined, the alkenyl typically contains 2 to 20 carbon atoms, for example, the alkenyl of 2 to 20 carbon atoms, the alkenyl of 6 to 20 carbon atoms, the alkene of 2 to 10 carbon atoms, or the alkenyl of 2 to 6 carbon atoms. Representative alkenyl comprises (for example) ethenyl, n-propenyl, isopropenyl, n-but-2-enyl, but-3-enyl, n-hex-3-enyl and the like. Additionally, the alkenyl can be optionally substituted.

The term “alkynyl” refers to a monovalent unsaturated hydrocarbyl group which may be linear-chain or branched-chain and has at least one and usually has 1, 2 or 3 carbon-carbon triple bonds. Unless otherwise defined, the alkynyl typically contains 2 to 20 carbon atoms, for example, the alkynyl of 2 to 20 carbon atoms, the alkynyl of 6 to 20 carbon atoms, the alkynyl of 2 to 10 carbon atoms or the alkynyl of 2 to 6 carbon atoms. Representative alkynyl comprises (for example) ethynyl, prop-2-ynyl(n-propynyl), n-but-2-ynyl, n-hex-3-ynyl, and the like. Additionally, the alkynyl can be optionally substituted.

The term “alkoxy” refers to an L-O-group, wherein L is alkyl. The alkoxy herein may be the alkoxy of 1 to 5 carbon atoms or may be the alkoxy of 1 to 5 carbon atoms and substituted by F or Cl.

### I. CATHODE MATERIAL

Since the commercial application of lithium ion batteries, academics and enterprises have conducted in-depth research on the lithium ion batteries. The most important research focus is obtaining the lithium ion batteries with high energy density, good rate characteristics and long service life. In order to meet the demand of people for high energy density of the lithium ion batteries, the voltage platform of the lithium ion batteries needs to be continuously improved. However, as the voltage increases, the side reaction between the cathode active material and the electrolyte becomes more of a concern, and the surface layer of the cathode active material will be subjected to phase change and is deactivated, resulting in an increase in impedance and a loss in capacity. Further, the electrolyte is oxidized on the surface of the cathode active material to form by-products which then adhere to the surface of the cathode active material, thereby further causing the increase in impedance and rapid decay of capacity. Therefore, it is very important to improve the stability of the surface of the cathode active material while the energy density of the lithium ion battery is improved.

In the prior art, the surface of the cathode active material may be coated to improve the stability of the surface of the cathode material. The coating layer can appropriately isolate the surface of the cathode active material from the electrolyte, and suppress the side reaction between the surface of the cathode active material and the electrolyte, thereby improving the surface stability of the cathode material.

Commonly used coating materials are mainly metal oxides such as oxides of Al, Mg, and Ti. However, an important drawback in coating with the metal oxide is that it is difficult to achieve a large-area coating, the contact and side reactions between the electrolyte and the cathode material cannot be effectively reduced, and the improvement effect is not satisfactory. In addition, when metal oxide particles are accumulated on the surface of the cathode material, the metal oxide particles may hinder the lithium ions from being intercalated into or deintercalated from the cathode active material to some extent, thereby increasing the DC resistance (DCR) of the lithium ion battery, and causing deterioration of the rate performance.

In addition, some cathode materials are very sensitive to water content. For example, high nickel materials (the proportion of Ni in the material is relatively large) are very easily affected by water content in the air during processing, resulting in rapid deterioration of the surface structure of the material. This is mainly due to a high lithium ratio of the high nickel material and the high pH value of the material per se, which render the material more easily to react with the water content through the action of hydrogen bonds to form residual lithium (LiOH, Li₂O, Li₂CO₃, etc.) on the surface. The formation of the residual lithium will reduce the actual capacity of the cathode material and affect other electrochemical properties of the cathode material. Therefore, it is often necessary to carry out the preparation of the above cathode material or perform other operations in a drying room, which obviously increases production costs and is disadvantageous for industrial production.

In order to solve the above technical problems, the present application provides a cathode material, comprising a matrix and a coating layer disposed on the surface of the matrix, wherein the matrix comprises a cathode active material capable of reversibly intercalating or deintercalating lithium ions. The coating layer comprises an organic material having the general formula X—R—CₙFₐCl_{b}, wherein R is a hydrocarbyl and the X is a siloxane group having the following general formula:

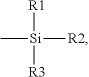

wherein R1, R2 and R3 respectively and independently represent an alkoxy having 1 to 5 carbon atoms or an alkoxy having 1 to 5 carbon atoms and substituted by F or Cl, n is an integer greater than or equal to 7, a and b are integers greater than or equal to 0 respectively, and a+b=2n+1.

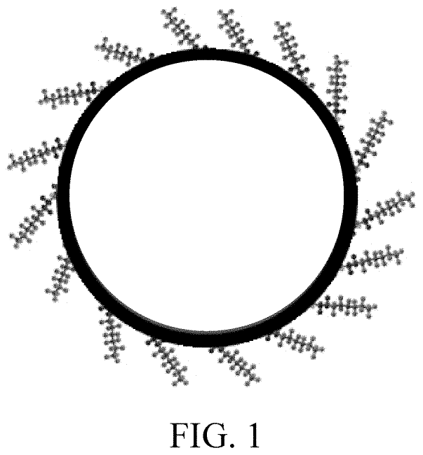

FIG. 1 is a schematic structural view of a cathode material coated by an organic material according to the present application. As shown in FIG. 1, the organic material X—R—CₙFₐCl_{b} is dispersed around the cathode active material (i.e., the matrix) in the form of single molecules. Specifically, the siloxane group X terminal of the organic molecule X—R—CₙFₐCl_{b} is adhered to the surface of the cathode active material. By taking Si—(O—CH₃)₃ as an example of the siloxane group X, the three —O—CH₃ are strongly adhered to the surface of the cathode active material in the form of a triangle. The other terminal —CₙFₐCl_{b} of the organic molecule X—R—CₙFₐCl_{b} will “hang” around the cathode active material.

It is noticeable that —CₙFₐCl_{b} is insoluble in the electrolyte of the lithium ion battery, so the solvent and solute molecules in the electrolyte are prevented from approaching the cathode active material to a certain extent, thereby playing a role of isolating the electrolyte from the cathode active material. However, —CₙFₐCl_{b} not only does not hinder the transport of the lithium ions to the cathode active material, but also promotes the transport of the lithium ions to the cathode active material. This is because —CₙFₐCl_{b} builds a clustered channel for the transport of the lithium ions, thereby causing the lithium ions to approach the cathode active material more easily and achieving rapid intercalating or deintercalating. In other words, the coated organic molecular layer can function as a lithium ion conductor, and the purpose of rapid transport of the lithium ions can be achieved without needing the lithium ions to cause desolvation on the surface of the cathode material in contact with the electrolyte.

It can be known that the organic coating layer described in the present application can not only realize the function of a conventional coating layer (i.e., isolating the electrolyte from the cathode active material), but also can function as a lithium ion conductor (i.e., promoting the transport of the lithium ions). Therefore, the cathode material coated with the organic material X—R—CₙFₐCl_{b} as described in the present application can reduce the impedance and improve the rate performance of the cathode material while improving the structural stability of the cathode material.

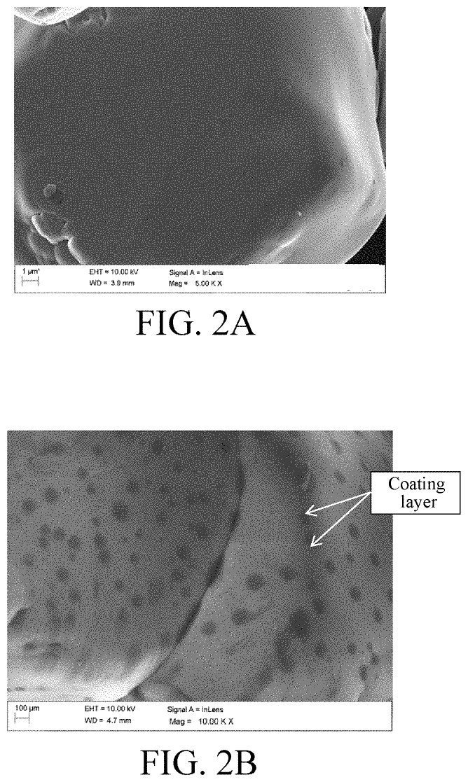

FIG. 2A and FIG. 2B are SEM images by a ZEISS model Sigma 300 of uncoated lithium cobalt oxide synthesized in Comparative Example 1 and coated lithium cobalt oxide synthesized in Embodiment 9 of the present application respectively. As shown in FIG. 2A, the surface of the lithium cobalt oxide without any coating tends to be smooth. As shown in FIG. 2B, after coated with the organic material of the present application, the organic coating layer is deposited on the surface of the lithium cobalt oxide over a large area.

In conclusion, it is known that by coating the cathode active material with an organic material having the general formula X—R—CₙFₐCl_{b}, large-area coating, or even the complete coating of the cathode active material can be achieved. Furthermore, the organic material of the formula X—R—CₙFₐCl_{b} acts as single molecules on the surface of the cathode material, and can form a plurality of lithium ion channels to promote rapid transport of the lithium ions. Therefore, the lithium ion battery prepared by the above cathode material not only does not experience the phenomenon of “increase of DC internal resistance and deterioration of rate performance” as in the prior art, but “reduces DC internal resistance of the lithium ion battery and improves the rate performance of the battery lithium ion.” In addition, the cathode material coated with a hydrophobic organic material of the general formula X—R—CₙFₐCl_{b} will become less sensitive to water content in the air, so that the cathode material can be transferred to a conventional plant or a conventional workshop for preparation or other operations, which greatly reduces production costs.

According to some embodiments of the present application, in the organic molecule of X—R—CₙFₐCl_{b}, R is a linear chain hydrocarbyl optionally having 1 to 20 carbon atoms or a branched chain hydrocarbyl optionally having 3 to 20 carbon atoms. Additionally, the hydrocarbyl can be optionally substituted. For example, the hydrocarbyl may be substituted with a halogen comprising fluorine, chlorine, bromine, and iodine. In some embodiments, R is a linear chain hydrocarbyl optionally having 1 to 10 carbon atoms, and optionally substituted by fluorine or chlorine. In yet other embodiments, the molecular formula of the organic material may be represented by X—(C_{c}H_{2c})—CₙFₐCl_{b}, wherein c is an integer greater than or equal to 1 and less than or equal to 5.

When the number of the carbon atoms in the —CₙFₐCl_{b} group is too small, the electrochemical performance of the cathode active material cannot be improved insufficiently, and an effective cluster channel also cannot not be constructed for lithium ion transport. As the number of the carbon atoms in the —CₙFₐCl_{b} group increases, the thickness of the coating layer also increases accordingly. By appropriately increasing the thickness of the coating layer, the contact between the electrolyte and the cathode active material can be more effectively reduced or even avoided, thereby improving the cycle stability of the cathode material. In addition, with the growth of the carbon chain of the —CₙFₐCl_{b} group, the cluster channel formed by —CₙFₐCl_{b} for lithium ion transport will be longer, and the desolvation effect will be more obvious, which is more advantageous to the transport of the lithium ions and improves the rate performance of the cathode material. In some embodiments, n in the —CₙFₐCl_{b} group is an integer greater than or equal to 7, an integer greater than or equal to 10, an integer greater than or equal to 15, an integer greater than or equal to 20, an integer greater than or equal to 25, an integer greater than or equal to 30, an integer greater than or equal to 35, an integer greater than or equal to 40, or an integer greater than or equal to 50.

According to some embodiments of the present application, the —CₙFₐCl_{b} group of the organic material may be a linear chain structure or a branched chain structure. In some embodiments, the —CₙFₐCl_{b} group of the organic is linear-chain. When the —CₙFₐCl_{b} group of the organic is linear-chain, a smoother lithium ion transport channel can be formed, thereby further accelerating the transport of the lithium ions.

According to some embodiments of the present application, R1, R2 and R3 in the X group of the organic material may respectively and independently be a C₁-C₅ linear chain alkoxy, or a C₁-C₅ linear chain alkoxy substituted with F or Cl. In some embodiments, R1, R2 and R3 may respectively and independently be a C₁-C₃ linear chain alkoxy, or a C₁-C₃ linear chain alkoxy substituted with F or Cl. In some embodiments, R1, R2 and R3 may respectively and independently be —OCH₃, —OCH₂F, —OCHF₂, —OCF₃, —OCH₂Cl, —OCHCl₂, —OCCl₃, —OC₂H₅, —OCH₂CF₃, —OCHFCF₃, —OCF₂CH₂F, —OCF₂CHF₂, —OCF₂CF₃, —OCH₂CCl₃, —OCHClCCl₃, —OCCl₂CH₂Cl, —OCCl₂CHCl₂, —OCCl₂CCl₃, —OC₃H₇, —OCH₂CH₂CH₂F, —OCH₂CH₂CHF₂, —OCH₂CH₂CF₃, —OCH₂CHFCH₃, —OCH₂CHFCH₂F, —OCH₂CHFCHF₂, —OCH₂CHFCF₃, —OCH₂CF₂CH₃, —OCH₂CF₂CH₂F, —OCH₂CF₂CHF₂, —OCH₂CF₂CF₃, —OCHFCF₂CH₂F, —OCHFCF₂CHF₂, —OCHFCF₂CF₃, —OCH₂CH₂CH₂Cl, —OCH₂CH₂CHCl₂, —OCH₂CH₂CCl₃, —OCH₂CHClCH₃, —OCH₂CHClCH₂Cl, —OCH₂CHClCHCl₂, —OCH₂CHClCCl₃, —OCH₂CCl₂CH₃, —OCH₂CCl₂CH₂Cl, —OCH₂CCl₂CHCl₂, —OCH₂CCl₂CCl₃, —OCHClCCl₂CH₂Cl, —OCHClCCl₂CHCl₂ or —OCHClCCl₂CCl₃.

According to some embodiments of the present application, the molecular formula of the organic material is (CH₃—O)₃—Si—(C₂H₄)—CₙF₍₂ₙ₊₁₎, wherein n is an integer greater than or equal to 7. For example, in these embodiments, the organic material may comprise, but not limited to, one of the following: SiO₃Cl₂H₁₃F₁₅, SiO₃Cl₃H₁₃F₁₇, SiO₃Cl₄H₁₃F₁₉, SiO₃Cl₅H₁₃F₂₁, SiO₃Cl₆H₁₃F₂₃, SiO₃Cl₇H₁₃F₂₅, SiO₃Cl₈H₁₃F₂₇, SiO₃Cl₉H₁₃F₂₉, SiO₃C₂₀H₁₃F₃₁, SiO₃C₂₁H₁₃F₃₃, SiO₃C₂₂H₁₃F₃₅, SiO₃C₂₃H₁₃F₃₇, SiO₃C₂₄H₁₃F₃₉, SiO₃C₂₅H₁₃F₄₁, SiO₃C₂₆H₁₃F₄₃, SiO₃C₂₇H₁₃F₄₅, SiO₃C₂₈H₁₃F₄₇, SiO₃C₂₉H₁₃F₄₉, SiO₃C₃₀H₁₃F₅₁, SiO₃C₃₁H₁₃F₅₃, SiO₃C₃₂H₁₃F₅₅, SiO₃C₃₃H₁₃F₅₇, SiO₃C₃₄H₁₃F₅₉, SiO₃C₃₅H₁₃F₆₁, SiO₃C₃₆H₁₃F₆₃, SiO₃C₃₇H₁₃F₆₅, SiO₃C₃₈H₁₃F₆₇, SiO₃C₃₉H₁₃F₆₉, or SiO₃C₄₀H₁₃F₇₁.

In some embodiments, the mass percentage of the organic material relative to the cathode active material is about 0.05 wt % to about 10 wt % or about 0.05 wt % to about 5 wt %. By gradually increasing the coating content of the organic material, a larger area of coating can be achieved, and a thicker coating layer can also be constructed, thereby improving the electrochemical performances of the cathode material such as cycle performance, impedance characteristics and rate performance. However, when the coating content of the organic material is increased to a certain extent, the improvement of the electrochemical performances of the cathode material will become less obvious.

In some embodiments, the cathode active material may be selected from, but not limited to, lithium cobalt oxide, lithium manganese oxide, lithium nickel oxide, lithium nickel cobalt manganese oxide, lithium nickel cobalt aluminum oxide, nickel manganese spinel, lithium iron phosphate, or combinations thereof.

In some embodiments, the cathode active material is LiNiₓCo_{y}Mn_{z}T_{d}O₂, wherein 0≤x≤1, 0≤y≤1, and 0≤z≤1, wherein x, y, and z are not simultaneously zero, wherein T is selected from the group consisting of Mg, Al, Ti, Ca, Si, Ga, Ge, La, Y, Zr, Sc, Nb, Mo, Ce, and combinations thereof, wherein 0≤d≤0.05.

In some embodiments, the cathode active material is LiNiₓCo_{y}Mn_{z}T_{d}O₂, wherein 0.55≤x<1, 0≤y<0.45, and 0≤z<0.45, wherein T is selected from the group consisting of Mg, Al, Ti, Ca, Si, Ga, Ge, La, Y, Zr, Sc, Nb, Mo, Ce, and combinations thereof, wherein 0≤d≤0.05. When nickel is more than about 55% by mole of the sum of nickel, cobalt and manganese, the cathode active material is defined as a high nickel material. For high nickel material used as cathode active material, in addition to improved cycle performance, rate performance and impedance characteristics, the cathode material coated with the organic material of the present application also has the further additional advantage that the processing of the high nickel cathode material only needs to be carried out in a conventional plant, and does not need to be carried out in a dry environment as in the prior art.

### II. METHOD FOR PREPARING CATHODE MATERIAL

The embodiments of the present application also provide a method for preparing a cathode material. Specifically, the present application uses a low-cost wet coating method to prepare the above cathode material, and the method comprises the following two steps:

Step 1: dissolving the organic material in an organic solvent, and then mixing with a cathode active material capable of reversibly intercalating or deintercalating lithium ions to obtain a mixed solution; and

Step 2: heating the mixed solution to evaporate the organic solvent, thereby obtaining a cathode material where the cathode active material is coated with the organic material.

The above organic material refers to the organic material which has been discussed in detail in the above embodiments, and the above cathode active material refers to the cathode active material which has been discussed in detail in the above embodiments. The details are not repeated here.

According to the above preparing method, in some embodiments, the organic solvent may be selected from the group consisting of methanol, ethanol, propanol, isopropanol, and combinations thereof.

According to the above preparing method, in some embodiments, the heated and evaporated organic solvent can be recycled and reused to further reduce costs.

For example, when ethanol is selected as the organic solvent, the mixed solution obtained in step 1 can be heated at about 70° C. to about 80° C., and the cathode material coated by the organic material is obtained after the ethanol is volatilized. The evaporated ethanol can be further recycled and reused to reduce costs.

According to the above preparing method, in some embodiments, the volume of the organic solvent is mainly determined according to the mass of the cathode active material. For example, every 5 kg of cathode active material needs to be inter-miscible with about 600 ml of ethanol.

According to the above preparing method, in some embodiments, the mass fraction of the organic material relative to the cathode active material is adjusted by controlling the mass ratio of the organic material to the cathode active material. In some of these embodiments, the mass percentage of the organic material relative to the cathode active material is about 0.05 wt % to about 10 wt % or about 0.05 wt % to about 5 wt %.

The preparing method provided by the embodiments of the present application has the following characteristics and advantages:

Firstly, the preparing method is simple and easy, the reaction conditions can be easily controlled, and the resources can be recycled and reused. Given the above, the preparing method is very suitable for industrial production, and has broad commercial application prospects.

Secondly, the coating process is a physical coating process, that is, the organic coating layer is physically deposited on the surface of the cathode active material without causing any impact on the crystal structure of the cathode active material per se. For example, in the above preparing method, the organic material is dissolved in an organic solvent and then mixed with the cathode active material. After the organic solvent is heated and volatilized, the siloxane group X terminal of the organic molecule is adhered to the surface of the cathode active material. The other terminal —CₙFₐCl_{b} of the organic molecule will “hang” around the cathode active material.

In addition, the organic material is insoluble in the electrolyte, so the addition of the electrolyte does not dissolve and destroy the coating layer during slurry stirring. In addition, the organic material per se has a relatively high boiling point (about 200° C. or above). Therefore, in the process of producing and processing an electrochemical device (for example, coating, high-temperature baking, etc.) by using the cathode material coated with the above organic material, the coating layer will not be easily damaged.

### III. ELECTROCHEMICAL DEVICE

The embodiments of the present application also provide an electrochemical device comprising the cathode material of the present application. The electrochemical device comprises a cathode comprising the cathode material of the present application, an anode comprising an anode material, a separator, and an electrolyte. The cathode of the present application contains a cathode active material layer formed on the surface of a cathode current collector. The cathode active material layer contains the cathode material described herein. In some embodiments, the electrochemical device is a lithium ion battery. In some embodiments of the present application, the cathode current collector may be, but not limited to, an aluminum foil or a nickel foil, and the anode current collector may be, but not limited to, a copper foil or a nickel foil.

The anode comprises an anode material capable of absorbing and releasing lithium (Li) (hereinafter, sometimes referred to as “an anode material capable of absorbing/releasing lithium (Li)”). The anode material capable of absorbing/releasing lithium (Li) may comprise, but not limited to, a carbon material, a metal compound, an oxide, a sulfide, a nitride of lithium such as LiN₃, a lithium metal, and a metal and a polymer material which form an alloy with lithium.

The carbon material may comprise, but not limited to, low graphitized carbon, easily graphitized carbon, artificial graphite, natural graphite, mesocarbon microbeads, soft carbon, hard carbon, pyrolytic carbon, coke, vitreous carbon, an organic polymer-compound sintered body, carbon fiber, and activated carbon. The coke may comprise pitch coke, needle coke, and petroleum coke. The organic polymer-compound sintered body refers to a material obtained by calcining a polymer material (for example, phenol plastic or furan resin) at a suitable temperature and carbonizing the same. These materials can be classified into low graphitized carbon or easily graphitized carbon. The polymer material can comprise, but not limited to, polyacetylene and polypyrrole.

Further, in these anode materials capable of absorbing/releasing lithium (Li), the materials of which the charging and discharging voltages are close to the charging and discharging voltages of lithium metal are selected. The reason is that the lower the charging and discharging voltages of the anode material are, the more easily the lithium ion battery has a higher energy density. The anode material may be selected from carbon material since the crystal structures thereof are only slightly changed upon charging and discharging. Therefore, better cycle characteristics and larger charging and discharging capacities can be obtained. In particular, graphite can be chosen since it has a large electrochemical equivalent and a high energy density.

Further, the anode material capable of absorbing/releasing lithium (Li) may comprise elemental lithium metal, metal elements and semimetal elements capable of forming an alloy with lithium (Li), alloys and compounds comprising such elements, and the like. In particular, the above materials are used together with the carbon material since in such case, good cycle characteristics as well as high energy density can be obtained. In addition to the alloys comprising two or more metal elements, the alloys used herein also comprise alloys containing one or more metal elements and one or more semi-metal elements. The alloy may be in one of the following states: a solid solution, a eutectic crystal (eutectic mixture), an intermetallic compound, and a mixture thereof.

Examples of the metal elements and the semimetal elements may comprise tin (Sn), lead (Pb), aluminum (Al), indium (In), silicon (Si), zinc (Zn), antimony (Sb), antimony (Bi), Cadmium (Cd), magnesium (Mg), boron (B), gallium (Ga), germanium (Ge), arsenic (As), silver (Ag), zirconium (Zr), yttrium (Y), and hafnium (Hf). Examples of the above alloys and compounds may comprise a material having a chemical formula: MaₛMbₜLiᵤ and a material having a chemical formula: MaₚMc_{q}Mdᵣ. In these chemical formulae, Ma represents at least one of the metal elements and the semimetal elements capable of forming an alloy with lithium. Mb represents at least one of the metal elements and the semimetal elements other than lithium and Ma. Mc represents at least one of non-metallic elements. Md represents at least one of the metal elements and the semi-metal elements other than Ma. In addition, s, t, u, p, q, and r satisfy s>0, t≥0, u≥0, p>0, q>0 and r≥0.

Further, the inorganic compound not comprising lithium (Li), such as MnO₂, V₂O₅, V₆O₁₃, NiS, and MoS, may be used in the anode.

The above lithium ion battery further comprises the electrolyte. The electrolyte may be one or more of a gel electrolyte, a solid electrolyte, and a liquid electrolyte. The electrolyte comprises a lithium salt and a nonaqueous solvent.

The lithium salt is one or more of LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiSiF₆, LiBOB, and lithium difluoroborate. For example, LiPF₆ is selected as the lithium salt since LiPF₆ has high ionic conductivity and improved cycle characteristics.

The nonaqueous solvent may be a carbonate compound, a carboxylate compound, an ether compound, other organic solvents, or combinations thereof.

The carbonate compound may be a chain carbonate compound, a cyclic carbonate compound, a fluorocarbonate compound, or combinations thereof.

Examples of the chain carbonate compound are diethyl carbonate (DEC), dimethyl carbonate (DMC), dipropyl carbonate (DPC), methyl propyl carbonate (MPC), ethylene propyl carbonate (EPC), ethyl methyl carbonate (MEC), and combinations thereof. Examples of the cyclic carbonate compound are ethylene carbonate (EC), propylene carbonate (PC), butylene carbonate (BC), vinyl ethylene carbonate (VEC), propyl propionate (PP), and combinations thereof. Examples of the fluorocarbonate compound are fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene glycol carbonate, 1,1,2-trifluoro-2-methylethylene carbonate, trifluoromethylethylene carbonate, and combinations thereof.

Examples of the carboxylate compound are methyl acetate, ethyl acetate, n-propyl acetate, t-butyl acetate, methyl propionate, ethyl propionate, γ-butyrolactone, azlactone, valerolactone, mevalonolactone, caprolactone, methyl formate, and combinations thereof.

Examples of the ether compounds are dibutyl ether, tetraglyme, diglyme, 1,2-dimethoxyethane, 1,2-diethoxyethane, ethoxymethoxy Ethylethane, 2-methyltetrahydrofuran, tetrahydrofuran, and combinations thereof.

Examples of the other organic solvents are dimethyl sulfoxide, 1,2-dioxolane, sulfolane, methyl sulfolane, 1,3-dimethyl-2-imidazolidinone, N-methyl-2-pyrrolidone, methanamide, dimethylformamide, acetonitrile, trimethyl phosphate, triethyl phosphate, trioctyl phosphate, phosphate, and combinations thereof.

According to the embodiments of the present application, the lithium ion battery further comprises the separator. When the lithium ions in the electrolyte are allowed to pass through the separator in the lithium ion battery, the separator in the lithium ion battery avoids direct physical contact between the anode and the cathode and prevents the occurrence of a short circuit. The separator is typically made of a material which is chemically stable and inert when in contact with the electrolyte and the electrode. Meanwhile, the separator needs to have mechanical robustness to withstand the stretching and piercing of the electrode material, and the pore size of the separator is typically less than about 1 micron. Various separators comprising microporous polymer membranes, non-woven mats and inorganic membranes have been used in the lithium ion batteries, wherein the polymer membranes based on microporous polyolefin materials are the most commonly used separators in combination with the liquid electrolyte. The microporous polymer membranes can be made very thin (typically about 25 μm) and highly porous (typically about 40%) to reduce electrical resistance and improve ion conductivity. Meanwhile, the polymer membrane still has mechanical robustness. Those skilled in the art will appreciate that various separators widely used in the lithium ion batteries are suitable for use in the present application.

Although the foregoing illustrates using a lithium ion battery as an example, after reading the present application, those skilled in the art can conceive that the cathode material of the present application can be used for other suitable electrochemical devices. Such electrochemical devices comprise any device which generates an electrochemical reaction, and specific examples thereof comprise all types of primary batteries, secondary batteries, fuel cells, solar cells, or capacitors. In particular, the electrochemical device is a lithium secondary battery, comprising a lithium metal secondary battery, a lithium ion secondary battery, a lithium polymer secondary battery, or a lithium ion polymer secondary battery.

### IV. APPLICATION

The electrochemical device manufactured from the cathode material according to the present application is suitable for electronic devices in various fields.

The use of the electrochemical device of the present application is not particularly limited and can be used for any use known in the art. In one embodiment, the electrochemical device of the present application can be used for, but not limited to, notebook computers, pen input computers, mobile computers, e-book players, portable telephones, portable fax machines, portable copy machines, portable printers, headset stereo headphones, VCRs, LCD TVs, portable cleaners, portable CD players, mini discs, transceivers, electronic notebooks, calculators, memory cards, portable recorders, radios, backup powers, motors, cars, motorcycles, power bicycles, bicycles, lighting fixtures, toys, game consoles, clocks, power tools, flashlights, cameras, large household batteries, lithium ion capacitors, etc.

Hereinafter, the preparation and efficiency of the lithium ion battery of the present application are explained by taking the lithium ion battery as an example and describing the specific embodiments for preparing a cathode material of the present application and test manners for the electrochemical device. Those skilled in the art will understand that the preparing method described in the present application is merely an example, and any other suitable preparing methods are within the scope of the present application.

### V. EMBODIMENTS

Preparation of Lithium Ion Battery

The cathode materials in the embodiments and comparative examples were prepared into lithium ion batteries by the following preparing method. Specifically, the cathode material prepared in the following embodiments and comparative examples, the conductive agent acetylene black, and the binder polyvinylidene fluoride (PVDF) were sufficiently stirred and mixed uniformly in N-methylpyrrolidone according to a weight ratio of 96:2:2 to prepare a cathode slurry. Then the obtained cathode slurry was uniformly coated on the front and back surfaces of the cathode current collector aluminum foil, and then was dried at 85° C. to obtain a cathode active material layer. Afterward, cold pressing, slitting, cutting and welding of cathode tabs thereon were performed to obtain the cathode.

The anode active material artificial graphite, the conductive agent acetylene black, the binder styrene-butadiene rubber (SBR), the thickener sodium carboxymethyl cellulose (CMC) were sufficiently stirred and mixed uniformly in deionized water according to a weight ratio of 96:1.5:1.5:1 to prepare an anode slurry. Then, the anode slurry was uniformly coated on the front and back surfaces of the anode current collector copper foil, and dried at 85° C. to form an anode active material layer. Afterward, cold pressing, slitting, cutting, and welding of anode tabs were performed to obtain the anode.

The lithium salt LiPF₆ and the non-aqueous organic solvent (ethylene carbonate (EC): diethyl carbonate (DEC): propylene carbonate (PC): propyl propionate (PP): vinylene carbonate (VC)=20:30:20:28:2, mass ratio) were prepared to a solution according to the mass ratio of 8:92, as an electrolyte of the lithium ion battery.

The separator was made of a ceramic-coated polyethylene (PE) material separator.

The cathode, the separator, and the anode were stacked in order, so that the separator was between the cathode and anode to play a role of isolation. The electrode component was placed in a package shell, and injected with the electrolyte and packaged, and the final lithium ion battery was obtained after formation.

Tests of Lithium Ion Battery

The prepared lithium ion battery was tested as follows, and the test conditions were as follows.

(1) Cycle Performance Test

The lithium ion batteries containing the cathode materials in the following embodiments and comparative examples were subjected to a cycle performance test.

At 45° C., the batteries were charged to a cutoff voltage at a constant current of 0.7C rate, and were then charged at such constant cutoff voltage until the current was lower than 0.05C, so that the lithium ion batteries were at a 4.5 V fully charged state. After fully charged, the batteries were discharged at a constant current rate of 1C, and the discharge capacity D₀ was recorded and used as a reference. The above steps were repeated and the discharge capacities thereof were recorded as D₁, D₂ . . . Dₙ, respectively. The capacity retention rate was calculated according to the following formula:

Capacity retention rate=Dₙ/D₀,n=1,2,3,4,5, . . .

For the batteries in Embodiments 1-10 and Comparative Examples 1-2 (i.e., the batteries use LiCoO₂ as the matrix of the cathode material), the cutoff voltage was 4.5 V. For the batteries in Embodiments 11-16 and Comparative Examples 3-4 (that is, the batteries use LiNi_{0.8}Co_{0.1}Mn_{0.1}O₂ as the matrix of the cathode material), the cutoff voltage was 4.4 V.

(2) Rate Performance Test

The rate performance test was performed on the lithium ion batteries containing the cathode materials in the following embodiments and comparative examples.

At a temperature of 25° C., the batteries were fully discharged to 3.0 V at a constant current rate of 0.2C, and were then fully charged to a cutoff voltage at a constant current of 0.7C. Afterward, the batteries were discharged at the discharge currents of 0.2C, 0.5C, 1 C, 1.5C and 2C respectively. The discharging capacities of the batteries at the above discharge currents were recorded as D_{0.2}, D_{0.5}, D₁, D_{1.5} and D₂, respectively. The capacity retention rate was calculated according to the following formula:

Capacity retention rate=D₂/D_{0.2.}

For the batteries in Embodiments 1-10 and Comparative Examples 1-2 (i.e., the batteries use LiCoO₂ as the matrix of the cathode material), the cutoff voltage was 4.5 V. For the batteries in Embodiments 11-16 and Comparative Examples 3-4 (that is, the batteries use LiNi_{0.8}Co_{0.1}Mn_{0.1}O₂ as a matrix of the cathode material), the cutoff voltage was 4.4 V.

(3) DC Resistance (DCR) Test

The direct current impedance (DCR) test was performed on the lithium ion batteries containing the cathode material in the following embodiments and comparative examples.

For the batteries in Embodiments 1-10 and Comparative Examples 1-2 (i.e., the batteries use LiCoO₂ as the matrix of the cathode material), at temperatures of 25° C. and 0° C., the DCR at 10%, 20%, and 70% of state of charge (SOC) was tested respectively. Firstly, the batteries were fully charged to 4.5 V at a constant current rate of 0.7C, then discharged to 70% of the amount of electricity at a discharge current of 0.1C, and then discharged for is at a discharge current of 1C to calculate the DCR (DCR@70%) at this point. Then, the batteries were discharged to 20% of the amount of electricity at a discharge current of 0.1C, and discharged for is at a discharge current of 1C to calculate the DCR (DCR@20%) at this point. Finally, the batteries were discharged to 10% of the amount of electricity at a discharge current of 0.1C, and were also discharged for 1 s at the discharge current of 1C, and the DCR (DCR@10%) at this point was calculated.

For the batteries of Embodiments 11-16 and Comparative Examples 3-4 (i.e., the batteries use LiNi_{0.8}Co_{0.1}Mn_{0.1}O₂ as a matrix of the cathode material), at the normal temperatures of 25° C. and 0° C., the DCR at 80%, 50% and 30% was tested respectively according to the same steps. In addition, when tested, these batteries were fully charged to 4.4 V.

### SPECIFIC EMBODIMENTS

Specific embodiments of the cathode material provided by the present application will be described in detail below. Embodiments 1-10 and Comparative Examples 1-2 used LiCoO₂ as the matrix of the cathode material, and Embodiments 11 to 16 and Comparative Examples 3-4 used LiNi_{0.8}Co_{0.1}Mn_{0.1}O₂ as the matrix of the cathode material.

### Embodiment 1

Lithium cobalt oxide and an organic material with the chemical formula (CH₃O—)₃—Si—(C₂H₄)—(C₇F₁₅) were fully stirred and mixed uniformly in alcohol according to a mass ratio of 99.95 wt % and 0.05 wt %. The obtained mixture was placed in an oven for drying, and then sieved to obtain the cathode material of Embodiment 1.

### Embodiments 2-5

The difference between Embodiments 2-5 and Embodiment 1 was only that the mass fraction of the organic material relative to the cathode active material was controlled to be 0.5 wt %, 1 wt %, 2 wt %, and 5 wt % respectively, while other treatment processes and parameters were the same as those in Embodiment 1.

### Embodiment 6

The difference between Embodiment 6 and Embodiment 1 was only that the organic molecules were replaced by (CH₃O—)₃—Si—(C₂H₄)—(C₁₀F₂₁), wherein —CₙFₐCl_{b} in the organic material contained 10 carbon atoms, while other treatment processes and parameters were the same as those in Embodiment 1.

### Embodiments 7-10

The difference between Embodiments 7-10 and Embodiment 6 was only that the mass fraction of the organic material relative to the cathode active material was controlled to be 0.5 wt %, 1 wt %, 2 wt %, and 5 wt %, respectively, while other treatment processes and parameters were the same as those in Embodiment 6.

### Comparative Example 1

The lithium cobalt oxide cathode material was not subjected to any coating treatment, and was directly prepared into a cathode and assembled into a battery.

### Comparative Example 2

The difference between Comparative Example 2 and Embodiment 3 was only that the organic molecules were replaced by (CH₃O—)₃—Si—(C₂H₄)—(C₃F₇), wherein —CₙFₐCl_{b} in the organic material contained 3 carbon atoms, while other treatment processes and parameters were the same as those in Embodiment 3.

### Embodiment 11

The cathode active material (LiNi_{0.8}Co_{0.1}Mn_{0.1}O₂) and the organic material with the chemical formula (CH₃O—)₃—Si—(C₂H₄)—(C₇F₁₅) were fully stirred and mixed uniformly in alcohol according to the mass ratio of 99.9 wt % and 0.1 wt %. The obtained mixture was placed in an oven for drying, and then sieved to obtain the cathode material described in Embodiment 11.

### Embodiments 12-16

The difference between Embodiments 12-16 and Embodiment 11 was only that the mass fraction of the organic material relative to the cathode active material was controlled to be 0.5 wt %, 1 wt %, 2 wt %, 3 wt %, and 5 wt % respectively, while other treatment processes and parameters were the same as those in Embodiment 11.

### Comparative Example 3

The LiNi_{0.8}Co_{0.1}Mn_{0.1}O₂ cathode material was not subjected to any coating treatment, and was directly prepared into a cathode and assembled into a battery.

### Comparative Example 4

The difference between Comparative Example 4 and Embodiment 13 was only that the organic molecules are replaced by (CH₃O—)₃—Si—(C₂H₄)—(C₃F₇), wherein —CₙFₐCl_{b} in the organic material contained 3 carbon atoms, while other treatment processes and parameters were the same as those in Embodiment 13.

The performance test was carried out on the lithium ion batteries obtained in Embodiments 1-16 and Comparative Examples 1-4 respectively. The test results were shown in Table 1.

Referring to Table 1, by comparing the battery performances of Embodiments 1-10 and Comparative Example 1, it is not difficult to see that the batteries of Embodiments 1-10 have better cycle performance, rate performance and impedance characteristics than those of Comparative Example 1. The same conclusion can be drawn by comparing the battery performances of Embodiments 11-16 and Comparative Example 3. This indicates that the organic coating layer described in the present application can effectively improve the cycle performance, rate performance, and impedance characteristics of the cathode active material.

By comparing the battery performances of Embodiments 3 and 8 with that of Comparative Example 2, it is not difficult to see that the batteries of Embodiments 3 and 8 have better cycle performance, rate performance, and impedance characteristics than those of Comparative Example 2. This indicates that when the number of the carbon atoms of —CₙFₐCl_{b} is too small, the electrochemical performance of the cathode active material cannot be insufficiently improved. Similarly, by comparing the battery performances of Embodiment 13 and Comparative Example 4, the similar conclusion can be drawn.

Secondly, by comparing the battery performances of Embodiments 1-5, it can be concluded that when the content of the organic material is gradually increased from 0.025 wt % to 5 wt %, the cycle performance and rate performance of the lithium ion batteries are continuously optimized and the impedance is constantly reduced. However, as the content of the organic material continues to increase, the improvement on the electrochemical performance of the lithium ion batteries will become less obvious. Similarly, by comparing the battery performances of Embodiments 11-16, the same conclusion can be drawn.

Further referring to Table 1, by comparing the battery performances of Embodiments 1-5 and Embodiments 6-10, it is not difficult to see that provided that the coating amount of the organic material remains unchanged, the more the carbon atoms in the —CₙFₐCl_{b} group in the organic material there are, the better the obtained cycle performance and rate performance of the batteries are.

Further, the process of preparing the lithium ion batteries using the cathode materials of Embodiments 11 to 16 described in Table 1 was carried out in a conventional plant. Referring to the battery performance data in Table 1, the obtained lithium ion batteries still have good cycle performance, rate performance and impedance characteristics. It can be seen that for the high nickel material as the cathode active material, using the organic material coating layer described in the present application to coat the high nickel material can reduce restrictions on production conditions, thereby reducing production costs, and being more advantageous for industrial production.

TABLE 1

| | Parameters of embodiments | | | | | | | | | | |
|---|---|---|---|---|---|---|---|---|---|---|---|
| | and comparative examples | | | | | | | | | | |
| | | | Number | | | | | | | | |
| | | | n of | | | | | | | | |
| | | | carbon | Battery performance | | | | | | | |
| | | Addi- | atoms | Cycle | Rate | DCR | DCR | DCR | DCR | DCR | DCR |
| Embodi- | | tion | in - | performance | performance | 25° | 25° | 25° | 0° | 0° | 0° |
| ments | Core | wt % | CₙFₐCl_{b} | 4.5 V@45° C. | 2 C | C.@70% | C.@20% | C.@10% | C.@70% | C.@20% | C.@40% |
| 1 | LiCoO₂ | 0.05 | 7 | 200cls @ 80% | 85.3% | 74.3 | 81.8 | 86.2 | 268.7 | 283.9 | 304.5 |
| 2 | LiCoO₂ | 0.5 | 7 | 220cls @ 80% | 88.2% | 72.6 | 77.4 | 83 | 234.1 | 245.4 | 297.5 |
| 3 | LiCoO₂ | 1 | 7 | 350cls @ 80% | 90.8% | 65.6 | 70.8 | 73.4 | 209.9 | 241.6 | 286.3 |
| 4 | LiCoO₂ | 2 | 7 | 400cls @ 80% | 91.2% | 63.4 | 68.9 | 70.2 | 206.4 | 240.1 | 280.8 |
| 5 | LiCoO₂ | 5 | 7 | 390cls @ 80% | 91.5% | 60.3 | 66.3 | 68.4 | 203.1 | 238.2 | 276.3 |
| 6 | LiCoO₂ | 0.05 | 10 | 250cls @ 80% | 86.0% | 73.1 | 80.8 | 85.2 | 265.3 | 281.4 | 303.2 |
| 7 | LiCoO2 | 0.5 | 10 | 260cls @ 80% | 88.3% | 71.5 | 76.2 | 82.3 | 233.5 | 245.2 | 297.1 |
| 8 | LiCoO₂ | 1 | 10 | 380cls @ 80% | 91.6% | 64.5 | 68.9 | 72.3 | 208.1 | 239.5 | 285.2 |
| 9 | LiCoO₂ | 2 | 10 | 420cls @ 80% | 92.0% | 62 | 67.1 | 68.9 | 206 | 237.3 | 280.1 |
| 10 | LiCoO₂ | 5 | 10 | 430cls @ 80% | 92.1% | 59.9 | 65.1 | 67.2 | 202.1 | 236.1 | 275.3 |

| | | Addi- | | Cycle | Rate | DCR | DCR | DCR | DCR | DCR | DCR |
|---|---|---|---|---|---|---|---|---|---|---|---|
| Comparative | | tion | Number | performance | performance | 25° | 25° | 25° | 0° | 0° | 0° |
| examples | Core | wt % | n | 4.5 V@45° C. | 2 C | C.@70% | C.@20% | C.@10% | C.@70% | C.@20% | C.@10% |
| 1 | LiCoO₂ | / | / | 150cls @ 80% | 76.7% | 79.8 | 85.7 | 88.1 | 276 | 287.3 | 300.7 |
| 2 | LiCoO₂ | 1 | 3 | 160cls @ 80% | 80% | 79.1 | 85.5 | 88.1 | 276.4 | 287.4 | 300.5 |

| | | Addi- | | Cycle | Rate | DCR | DCR | DCR | DCR | DCR | DCR |
|---|---|---|---|---|---|---|---|---|---|---|---|
| Embodi- | | tion | | performance | performance | 25° | 25° | 25° | 0° | 0° | 0° |
| ments | Core | wt % | n | 4.4 V@45° C. | 2 C | C.@80% | C.@50% | C.@30% | C.@80% | C.@50% | C.@30% |
| 11 | LiNi_{0.8}Co_{0.1}Mn_{0.1}O₂ | 0.1 | 7 | 550cls @ 80% | 80.7% | 44.3 | 60.1 | 67.4 | 80.2 | 74.8 | 71.1 |
| 12 | LiNi_{0.8}Co_{0.1}Mn_{0.1}O₂ | 0.5 | 7 | 600cls @ 80% | 81.1% | 40.2 | 55.8 | 65.6 | 75.4 | 71.4 | 67.7 |
| 13 | LiNi_{0.8}Co_{0.1}Mn_{0.1}O₂ | 1 | 7 | 650cls @ 80% | 82.5% | 36.3 | 52.9 | 62.2 | 66.4 | 62.6 | 59.5 |
| 14 | LiNi_{0.8}Co_{0.1}Mn_{0.1}O₂ | 2 | 7 | 670cls @ 80% | 83.1% | 34.5 | 50.3 | 65.6 | 61.2 | 58.6 | 56.2 |
| 15 | LiNi_{0.8}Co_{0.1}Mn_{0.1}O₂ | 3 | 7 | 700cls @ 80% | 83.5% | 34.2 | 50.6 | 62.6 | 60.0 | 56.0 | 55.3 |
| 16 | LiNi_{0.8}Co_{0.1}Mn_{0.1}O₂ | 5 | 7 | 710cls @ 80% | 83.8% | 34.2 | 49.1 | 62.1 | 59.2 | 55.8 | 53.2 |

| | | | | | Rate | | | | | | |
|---|---|---|---|---|---|---|---|---|---|---|---|
| | | Addi- | | Cycle | perfor- | DCR | DCR | DCR | DCR | DCR | DCR |
| Comparative | | tion | Number | performance | mance | 25° | 25° | 25° | 0° | 0° | 0° |
| examples | Core | wt % | n | 4.4 V@45° C. | 2 C | C.@80% | C.@50% | C.@30% | C.@80% | C.@50% | C.@30% |
| 3 | LiNi_{0.8}Co_{0.1}Mn_{0.1}O₂ | / | / | 500cls @ 80% | 79.8% | 62.5 | 75.4 | 85.2 | 91.0 | 86.0 | 81.7 |
| 4 | LiNi_{0.8}Co_{0.1}Mn_{0.1}O₂ | 1 | 3 | 520cls@80% | 80.2% | 55.0 | 64.0 | 71.0 | 86.0 | 80.0 | 76.0 |

References to “some embodiments”, “part of embodiments”, “one embodiment”, “another example”, “example”, “specific example” or “part of examples” in the whole specification mean that at least one embodiment or example in the application comprises specific features, structures, materials or characteristics described in the embodiments or examples. Thus, the descriptions appearing in the whole specification, for example, “in some embodiments”, “in the embodiment”, “in one embodiment”, “in another example”, “in an example”, “in a particular example” or “example”, do not necessarily refer to the same embodiment or example in the application. Furthermore, the particular features, structures, materials, or characteristics herein may be combined in one or more embodiments or examples in any suitable manner.

Although the illustrative embodiments have been shown and described, it will be understood by those skilled in the art that the above embodiments cannot be explained as limiting the present application. The embodiments can be changed, substituted and modified without departing from the spirit, principle and scope of the present application.

What is claimed is:

1. A cathode material, comprising:
a matrix, comprising a cathode active material capable of reversibly intercalating or deintercalating lithium ions; and
a coating layer, disposed on the surface of the matrix;
wherein the coating layer comprises an organic material having the general formula X—R—CₙFₐCl_{b}, wherein R is a hydrocarbyl and X is a siloxane group having the following general formula: 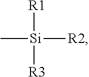
wherein R1, R2 and R3 respectively and independently represent an alkoxy group having 1 to 5 carbon atoms or an alkoxy group having 1 to 5 carbon atoms and substituted with F or Cl;
n is an integer greater than or equal to 7; and
a and b are integers greater than or equal to 0 respectively, and a+b=2n+1.

2. The cathode material according to claim 1, wherein R is a linear chain hydrocarbyl having 1 to 10 carbon atoms.

3. The cathode material according to claim 2, wherein a molecular formula of the organic material is X—(C_{c}H_{2c})—CₙFₐCl_{b}, wherein 1≤c≤5, and n is an integer greater than or equal to 10.

4. The cathode material according to claim 3, wherein a molecular formula of the organic material is (CH₃—O)₃—Si—(C₂H₄)—CₙF₍₂ₙ₊₁₎.

5. The cathode material according to claim 1, wherein —CₙFₐCl_{b} is linear-chain.

6. The cathode material according to claim 1, wherein a mass percentage of the organic material relative to the cathode active material is about 0.05 wt % to about 5 wt %.

7. The cathode material according to claim 1, wherein the cathode active material is LiNiₓCo_{y}Mn_{z}T_{d}O₂, wherein 0≤x≤1, 0≤y≤1, 0≤z≤1, wherein x, y, and z are not zero at the same time, wherein T is selected from the group consisting of Mg, Al, Ti, Ca, Si, Ga, Ge, La, Y, Zr, Sc, Nb, Mo, Ce, and combinations thereof, wherein 0≤d≤0.05.

8. The cathode material according to claim 7, wherein the cathode active material is LiNiₓCo_{y}Mn_{z}T_{d}O₂, wherein 0.55≤x<1, 0≤y<0.45, and 0≤z<0.45.

9. An electrochemical device, comprising a cathode, an anode, a separator, and an electrolyte, wherein the cathode comprises a cathode material comprising:
a matrix, comprising a cathode active material capable of reversibly intercalating or deintercalating lithium ions; and
a coating layer, disposed on the surface of the matrix;
wherein the coating layer comprises an organic material having the general formula X—R—CₙFₐCl_{b}, wherein R is a hydrocarbyl and X is a siloxane group having the following general formula: 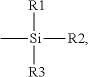
wherein R1, R2 and R3 respectively and independently represent an alkoxy group having 1 to 5 carbon atoms or an alkoxy group having 1 to 5 carbon atoms and substituted with F or Cl;
n is an integer greater than or equal to 7; and
a and b are integers greater than or equal to 0 respectively, and a+b=2n+1.

10. The electrochemical device according to claim 9, wherein R is a linear chain hydrocarbyl having 1 to 10 carbon atoms.

11. The electrochemical device according to claim 10, wherein a molecular formula of the organic material is X—(C_{c}H_{2c})—CₙFₐCl_{b}, wherein 1≤c≤5, and n is an integer greater than or equal to 10.

12. The electrochemical device according to claim 11, wherein a molecular formula of the organic material is (CH₃—O)₃—Si—(C₂H₄)—CₙF₍₂ₙ₊₁₎.

13. The electrochemical device according to claim 9, wherein —CₙFₐCl_{b} is linear-chain.

14. The electrochemical device according to claim 9, wherein a mass percentage of the organic material relative to the cathode active material is about 0.05 wt % to about 5 wt %.

15. The electrochemical device according to claim 9, wherein the cathode active material is LiNiₓCo_{y}Mn_{z}T_{d}O₂, wherein 0≤x≤1, 0≤y≤1, 0≤z≤1, wherein x, y, and z are not zero at the same time, wherein T is selected from the group consisting of Mg, Al, Ti, Ca, Si, Ga, Ge, La, Y, Zr, Sc, Nb, Mo, Ce, and combinations thereof, wherein 0≤d≤0.05.

16. The electrochemical device according to claim 15, wherein the cathode active material is LiNiₓCo_{y}Mn_{z}T_{d}O₂, wherein 0.55≤x<1, 0≤y<0.45, and 0≤z<0.45.

17. The electrochemical device according to claim 9, wherein the electrochemical device is a lithium ion battery.

18. An electronic device, comprising the electrochemical device according to claim 9.

19. A method for preparing a cathode material, comprising:
dissolving an organic material in an organic solvent, and then mixing with a cathode active material capable of reversibly intercalating or deintercalating lithium ions to obtain a mixed solution; and
heating the mixed solution to evaporate the organic solvent, thereby obtaining a cathode material comprising the cathode active material coated with the organic material,
wherein the organic material has the general formula X—R—CₙFₐCl_{b}, wherein R is a hydrocarbyl and X is a siloxane group having the following general formula: 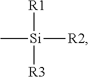
wherein R1, R2 and R3 respectively and independently represent an alkoxy group having 1 to 5 carbon atoms or an alkoxy group having 1 to 5 carbon atoms and substituted with F or Cl;
n is an integer greater than or equal to 7; and
a and b are integers greater than or equal to 0 respectively, and a+b=2n+1.

20. The method according to claim 19, further comprising recovering the evaporated organic solvent.
